(19) United States
(12) Patent Application Publication
(10) Pub. No.: US 2007/0079731 A1
(43) Pub. Date: Apr. 12, 2007

(54) Alkylene carbonates as water glass cure accelerants

(75) Inventors: John H. Clements, Round Rock, TX (US); Katty Darragas, Oudenaarde (BE); Howard P. Klein, Austin, TX (US)

Correspondence Address: Huntsman Corporation;Legal Department, 10003 Woodloch Forest Drive, The Woodlands, TX, 77380, US

(73) Assignee: Huntsman Petrochemical Corporation, The Woodlands, TX (US)

(21) Appl. No.: 10/577,455

(22) PCT Filed: Nov. 2, 2004
(86) PCT No.: PCT/US04/36438

§ 371 Date: Apr. 27, 2006

Related U.S. Application Data
(60) Provisional application No. 60/516,825, filed on Nov. 3, 2003.

(51) Int. Cl. C04B 28/26

(52) U.S. Cl. 106/603

(57) ABSTRACT

Provided herein are catalysts useful in the curing of cementitious mixtures, which catalysts comprise one or more alkylene carbonates in combination with glycerin carbonate. Through use of a catalyst according to the present invention, cementitious mixtures containing sodium silicate may be cured at low temperatures because the catalysts of the invention function well at low temperatures, even though they contain ethylene carbonate, a material whose melting point of 36° C. otherwise precludes its use as a cure accelerant for silicates. FIG. 1 is a graphical representation of the results shown in Table II.

### FIELD OF THE INVENTION

The present invention relates to the curing of cementitious mixtures. More particularly it relates to the curing of cementitious systems which contain sodium silicate, and to cure rate accelerants useful in such systems.

### BACKGROUND INFORMATION

It is known that alkylene carbonates such as ethylene carbonate, propylene carbonate and butylene carbonate, (hereafter referred to as EC, PC, and BC, respectively) enhance the rate of curing of aqueous sodium silicate, e.g. water glass, in the application of their use in foundry sand binders in the manufacture of various molded objects. The degree of cure enhancement is dependent on the type of alkylene carbonate employed. For instance, the order of enhancement observed for the aforementioned alkylene carbonates is: EC>PC>BC, i.e., ethylene carbonate causes a more rapid cure of a given system on an equimolar basis than do either propylene carbonate or butylene carbonate. This difference in the reactivity of substituted alkylene carbonates lends itself well for advantage to be taken in that blends of EC and PC or PC and BC can be prepared that exhibit varying degrees of cure enhancement over a wide range. In this way, the foundry industry can easily obtain binder formulations that provide ideal working times specific to particular processes or environmental conditions.

However, the use of carbonate blends in foundry applications has a disadvantage related to their freezing point. Although PC and BC have freezing points below −40° C., EC will freeze at temperatures below 36° C. For this reason, the use of EC or EC/PC blends that are rich in EC is problematic if fast curing is desired.

The present invention provides novel mixtures of commercially available alkylene carbonates that exhibit fast curing of water glass yet themselves freeze at sufficient low temperatures to enable their employment.

### SUMMARY OF THE INVENTION

Glycerine carbonate has the structure:

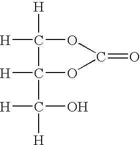

One embodiment of the present invention involves a process for causing curing of an aqueous solution containing a water-soluble silicate by addition of a liquid catalyst mixture comprising an alkylene carbonate to the aqueous solution, wherein the alkylene carbonate is selected from the group consisting of: ethylene carbonate, propylene carbonate, and butylene carbonate, and mixtures thereof, wherein the improvement comprises including an effective amount of glycerine carbonate in said liquid catalyst mixture to render said liquid catalyst mixture to have a freezing point that is below about 15 degrees centigrade, and preferably below about 0 degrees centigrade.

### DETAILED DESCRIPTION

The problems associated with the use of sodium silicate cure accelerators that contain EC stemming from the relatively high freezing point of EC are alleviated by the instant discovery that mixtures of PC and another alkylene carbonate known as glycerine carbonate (hereafter “GC”) accelerate the cure of sodium silicates to about the same extent as does pure ethylene carbonate. However, unlike EC, GC does not disadvantageously freeze at temperatures above −40° C. Thus, the invention provides blends of GC and PC that offer a wide range of curing times to the industry, while retaining liquid-state status over a broader temperature range than the cure accelerators of the prior art.

It is known that the reactivity of alkylene carbonates with amines follows the order: EC>PC>BC. Thus, the prior art teaches that the reactivity of the carbonates with amines decreases with the size of the substituent attached to the carbonate ring, and one of ordinary skill would naturally expect that GC should possess a relative reactivity somewhere between PC and BC, based on substituent size, given its molecular structure. However, as the data herein show, the reactivity of GC actually lies very close to that of EC in the case of catalyzing the cure of sodium silicate. Cure accelerator blends according to the invention containing GC were found to cure sodium silicate as fast as EC as the data set forth herein shows. This result is unexpected in view of the reaction rate of GC in reactions with other chemical species, such as amines.

The rate of sodium silicate cure in the presence of alkylene carbonates was determined by measuring the time required for the mixture to first show visible signs of gellation following the addition of the sodium silicate. In all cases, aqueous sodium silicate solution was added to a glass vial containing the desired alkylene carbonate or alkylene carbonate mixture. The resulting mixture was then stirred vigorously with a metal spatula and the time required for the mixture to change from a translucent liquid to an opaque gel was recorded. For each of the examples herein, the weight ratio of sodium silicate solution to carbonate(s) was maintained at 9:1 ( 10 wt. % carbonate).

Sodium silicate mixtures possessing different ratios of silica (SiO₂) to sodium oxide (Na₂O) were tested. Relevant properties of the different sodium silicate solution tested are given in the Table I below:

TABLE I

| | SiO₂/NaO₂ | Water | Density | Viscosity |
|---|---|---|---|---|
| Brand* | Ratio | (wt. %) | (g/ml) | (centipoise) |
| 1 | 3.22 | 62.4 | 1.38 | 180 |
| 2 | 3.21 | 61.7 | 1.40 | 237 |
| 3 | 2.40 | 52.9 | 1.56 | 600 |
| 4 | 1.80 | 62.5 | 1.44 | |

*Brand 1 -PQ Corporation, N ® Clear
*Brand 2 - Fisher Scientific Products, technical grade
*Brand 3 - PQ Corporation, RU ™, 10% dilution with water
*Brand 4 - PQ Corporation, STARSO ®

Table II below displays gel times (in seconds) for each of the aforementioned sodium silicate solutions in the presence of EC, PC, BC, GC, and mixtures thereof Data is given in the format X-Y, wherein X and Y represent the time required to reach the onset of gel and a fully gelled state, respectively. Note that the onset of gel is usually accompanied by an abrupt increase in the viscosity and cloudiness of the mixture, whereas a mixure that ceases to flow under the stirring action of the spatula is considered a gelled mixture. The time required for mixtures to fully harden was not measured. All values are an average of two trials.

TABLE II

| Carbonate Component | | | | | | | |
|---|---|---|---|---|---|---|---|
| (wt. %) | | | | Sodium Silicate Brand | | | |
| EC | PC | BC | GC | 1 | 2 | 3 | 4*** |
| 100 | — | — | — | 10-13 | 13-16 | 39-61 | 104-108 |
| | 100 | — | — | 23-29 | 61-70 | >240 | >240 |
| — | — | 100 | — | 215-234* | >240 | >240 | >240 |
| — | — | — | 100 | 10-24** | 12-30** | 14-36** | >240 |
| 25 | 75 | — | — | 14-18 | 26-32 | 240-260 | >240 |
| 50 | 50 | — | — | 13-16 | 12-16 | 150-164 | >240 |
| 75 | 25 | — | — | 10-12 | 12-16 | 103-114 | 195-199 |
| — | 90 | 10 | — | 27-33 | 81-87 | >240 | >240 |
| — | 70 | 30 | — | 46-60* | 122-130* | >240 | >240 |
| — | 50 | 50 | — | 68-82* | 182-197* | >240 | >240 |
| — | 95 | — | 5 | 18-22 | 48-54 | >240 | >240 |
| — | 90 | — | 10 | 16-20 | 31-39 | >240 | >240 |
| — | 80 | — | 20 | 10-12 | 13-22 | 235-252 | >240 |
| — | 70 | — | 30 | 10-12 | 11-16 | 151-168 | >240 |
| — | 50 | — | 50 | <10 | 10-15 | 58-76 | >240 |
| — | 25 | — | 75 | <10 | <10 | 33-43 | >240 |
| 90 | — | — | 10 | <10 | 10-14 | 52-59 | 102-109 |
| 75 | — | — | 25 | <10 | 10-14 | 34-46 | 107-114 |
| 40 | — | — | 60 | <10 | <10 | 25-35 | >240 |
| 20 | — | — | 80 | <10 | 12-20** | 19-31 | >240 |

*Unlike most mixtures, gellation of formulations containing BC is not accompanied by an abrupt viscosity increase. Rather, gellation occurs over a broader time range.
**Formulations containing significant amounts of GC are not initially compatible, which results in longer than expected mixing times to reach a gelled state.
***Unlike most mixtures, a slight to moderate exotherm accompanies gellation of all formulations containing sodium silicate brand 4.

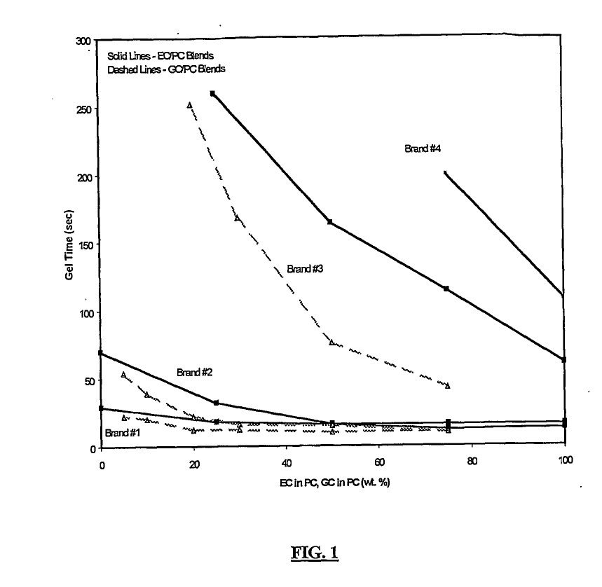

It can be concluded from the data in Table II that the general order of cure enhancement due to the presence of added alkylene carbonate is as follows: EC≅GC>PC>BC. It can also be concluded that the rate of cure is strongly dependent on the SiO₂/Na₂O ratio and increases with this ratio. A ratio of SiO₂/Na₂O greater than 2.4 is required if fast curing is desired. In general mixtures of GC/PC blends outperformed the analogous EC/PC blends for all but brand 4, which possesses an SiO₂/Na₂O ratio much too low to promote fast curing. In addition, EC/GC blends outperformed the analogous EC/PC blends as well. These results are set forth graphically in FIG. 1.

What is claimed is:

1. A process for causing curing of an aqueous solution containing a water-soluble silicate comprising: contacting an aqueous solution of a silicate having the formula SiO₂/M₂O in which M is selected from the group consisting of: Li, Na, K, and NR₄, wherein each R is independently hydrogen or a C₁-C₁₀ hydrocarbon group, with a liquid catalyst mixture that comprises glycerine carbonate and at least one other alkylene carbonate selected from the group consisting of: ethylene carbonate, propylene carbonate, and butylene carbonate.

2. A process according to claim 1 wherein said aqueous solution of a silicate contains between 10% and 90% water based on the total weight of said aqueous solution of a silicate.

3. A process according to claim 1 wherein said liquid catalyst mixture is present in any amount between about 1 and 30% by weight based on the total combined weight of said liquid catalyst mixture and said aqueous solution of a silicate.

4. A process according to claim 3 wherein the ratio SiO₂/M₂O is any ratio in the range of between 4:1 and 1:4.

5. A process according to claim 4 wherein said at least one other alkylene carbonate comprises ethylene carbonate, wherein M is sodium, and wherein said liquid catalyst mixture has a freezing point that is below about 15 degrees centigrade.

6. A process according to claim 1 wherein said aqueous solution is contacted with an amount of liquid catalyst mixture that is equal to between about 1 and about 30 percent by weight based on the total amount of silicate solution

7. A process according to claim 6 wherein the amount of silicon present in said aqueous solution is any amount between about 20 and about 80 percent by weight based on the total weight of the aqueous solution.

8. A process according to claim 6 wherein the amount of silicon present in said aqueous solution is any amount between about 40 and about 60 percent by weight based on the total weight of the aqueous solution.

9. A process according to claim 6 wherein the amount of glycerine carbonate present in said liquid catalyst mixture is any amount between about 5 and about 95% by weight based on the total weight of said liquid catalyst mixture.

10. A process according to claim 6 wherein the amount of glycerine carbonate present in said liquid catalyst mixture is any amount between about 20 and about 40% by weight based on the total weight of said liquid catalyst mixture.

11. A process according to claim 6 wherein said liquid catalyst mire comprises glycerine carbonate and ethylene carbonate, wherein ethylene carbonate is present in said liquid catalyst mixture in any amount between about 5 and about 95% by weight based on the total weight of said liquid catalyst mixture.

12. A process according to claim 6 wherein said liquid catalyst mixture comprises glycerine carbonate and ethylene carbonate, wherein ethylene carbonate is present in said liquid catalyst mixture in any amount between about 60 and about 80% by weight based on the total weight of said liquid catalyst mixture.

13. A process according to claim 6 wherein said liquid catalyst mixture comprises glycerine carbonate and propylene carbonate, wherein propylene carbonate is present in said liquid catalyst mixture in any amount between about 5 and about 95% by weight based on the total weight of said liquid catalyst mixture.

14. A process according to claim 6 wherein said liquid catalyst mixture comprises glycerine carbonate and propylene carbonate, wherein propylene carbonate is present in said liquid catalyst mixture in any amount between about 60 and about 90% by weight based on the total weight of said liquid catalyst mixture.

15. A process according to claim 6 wherein said liquid catalyst mixture comprises glycerine carbonate and butylene carbonate, wherein butylene carbonate is present in said liquid catalyst mixture in any amount between about 60 and about 90% by weight based on the total weight of said liquid catalyst mixture.

16. A process according to claim 1 wherein said silicate is present in any concentration between about 50 and about 500 grams per liter of silicon in said aqueous solution.

17. In a process for causing curing of an aqueous solution containing a water-soluble silicate by addition of a liquid catalyst mitre comprising an alkylene carbonate to said aqueous solution, wherein said alkylene carbonate is selected from the group consisting of: ethylene carbonate, propylene carbonate, and butylene carbonate, and mixtures thereof wherein the improvement comprises including an effective amount of glycerine carbonate in said liquid catalyst mixture to render said liquid catalyst mixture to have a freezing point that is below about 15 degrees centigrade.
